(19) United States
(12) Patent Application Publication
(10) Pub. No.: US 2010/0048162 A1
(43) Pub. Date: Feb. 25, 2010

(54) SYSTEM AND METHOD FOR EFFECTING SPECIAL TREATMENT OF EMERGENCY SERVICE CALLS ORIGINATING IN A TEMPORARILY DESIGNATED REGION

(75) Inventor: Lawrence W. Ciesla, Yorkville, IL (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(73) Assignee: WEST CORPORATION, Omaha, NE (US)

(21) Appl. No.: 12/194,250

(22) Filed: Aug. 19, 2008

(51) Int. Cl. H04M 11/04

(52) U.S. Cl. 455/404.2

(57) ABSTRACT

A system for effecting special treatment of emergency service calls originating in a temporarily designated region includes: (a) a geographic mapping unit; (b) a polygon managing unit coupled with the geographic mapping unit; at least one of the geographic mapping unit and the polygon managing unit being coupled with an emergency telephone network handling the emergency service calls; the polygon managing unit and the geographic mapping unit cooperating to effect designation of the region; and (c) a voice messaging unit coupled with the emergency telephone network and coupled with at least one of the geographic mapping unit and the polygon managing unit; the voice messaging unit providing a voice message responsive to the emergency service calls originating in the region substantially while the region is designated.

### FIELD OF THE INVENTION

The present invention is directed to telecommunication systems, and especially to effecting special treatment of emergency service calls originating in a temporarily designated region.

### BACKGROUND OF THE INVENTION

A problem presented to a Public Safety Answering Point (PSAP; sometimes referred to as a Public Safety Answering Position) in handling emergency service calls received via an emergency telephone network may occur, by way of example and not by way of limitation, immediately after an accident on an interstate or other highway. Numerous drivers passing by the locus of the accident driving in either direction on the interstate (or driving on cross roads intersecting the interstate) may dial 9-1-1 to report the accident. On very busy interstates it is possible that hundreds of cellular 9-1-1 calls may be made to report the same accident. Such a relatively sudden surge in 9-1-1 call volume can swamp a PSAP and occupy all of the call takers at the PSAP, thereby possibly preventing the call takers from responding to an emergency call regarding another emergency that is unrelated to the accident.

Prior art emergency telephone networks include cellular telephone switches connected to a 9-1-1 tandem telephone switch that routed an emergency service call to the correct PSAP based upon approximate location of the calling cellular phone. Prior to presenting the call to the 9-1-1 tandem switch, the cellular telephone switch queried a Mobile Positioning Center (MPC) or Gateway Mobile Location Center (GMLC) to obtain a pseudo telephone number that is selected based on the caller's approximate location. The 9-1-1 tandem switch was programmed to route any calls originating from the pseudo telephone number to a particular PSAP. In such a prior art system, the 9-1-1 tandem switch is unable to do anything other than route the call to the correct PSAP.

It would be useful if a PSAP call taker or operator could designate a geographic incident region substantially surrounding the location of an accident, identify emergency service calls originating within that designated incident region and provide an alert indication to callers from the incident region that the incident has already been reported. By way of example and not by way of limitation, a PSAP operator could generate an alert indication in the form of a voice message to be played only to cellular callers dialing 9-1-1 while physically inside the incident region defined by a polygon drawn by the PSAP operator. The voice message might say something like “If you are calling about the accident on 125 near mile marker 247 please hang up. For any other emergency please stay on the line.” This problem of sudden surges in 9-1-1 call volume associated with an incident occurring in a well-traveled locale is not known to have been previously addressed or solved.

There is a need for a system and method for effecting special treatment of emergency service calls originating in a temporarily designated region to alert callers that an incident has already been reported to reduce call volume from the region associated with repeat reports of a single incident.

### SUMMARY OF THE INVENTION

A system for effecting special treatment of emergency service calls originating in a temporarily designated region includes: (a) a geographic mapping unit; (b) a polygon managing unit coupled with the geographic mapping unit; at least one of the geographic mapping unit and the polygon managing unit being coupled with an emergency telephone network handling the emergency service calls; the polygon managing unit and the geographic mapping unit cooperating to effect designation of the region; and (c) a voice messaging unit coupled with the emergency telephone network and coupled with at least one of the geographic mapping unit and the polygon managing unit; the voice messaging unit providing a voice message responsive to the emergency service calls originating in the region substantially while the region is designated.

A method for effecting special treatment of emergency service calls handled by an emergency telephone network and originating in a temporarily designated region includes: (a) in no particular order: (1) providing a geographic mapping unit; (2) providing a polygon managing unit; and (3) providing a voice messaging unit; (b) in no particular order: (1) coupling the polygon managing unit coupled with the geographic mapping unit; (2) coupling at least one of the geographic mapping unit and the polygon managing unit with the emergency telephone network; and (3) coupling the voice messaging unit with the emergency telephone network and with at least one of the geographic mapping unit and the polygon managing unit; (c) operating the polygon managing unit and the geographic mapping unit cooperatively to effect designation of the region; and (d) operating the voice messaging unit to provide a voice message responsive to the emergency service calls originating in the region substantially while the region is designated.

It is, therefore, a feature of the present invention to provide a system and method for effecting special treatment of emergency service calls originating in a temporarily designated region to alert callers that an incident has already been reported to reduce call volume from the region associated with repeat reports of a single incident.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system for effecting the present invention.

FIG. 2 illustrates call flow in the system of the present invention after a cellular phone places an emergency service call to 9-1-1.

FIG. 3 is a schematic diagram illustrating arranging polygons for particular purposes in presenting geographic data.

FIG. 4 is a schematic diagram illustrating application of a polygon to a geographic presentation.

FIG. 5 is a flow diagram illustrating the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

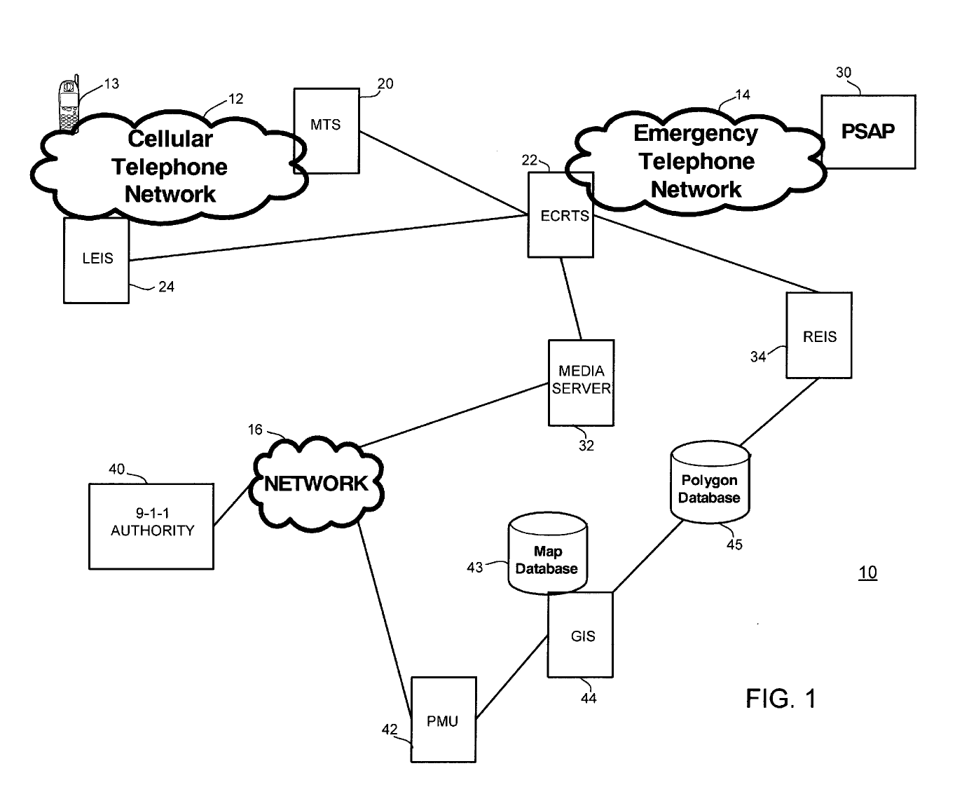

FIG. 1 is a schematic illustration of a system for effecting the present invention. In FIG. 1, a call handling system 10 includes a cellular telephone network 12, an emergency telephone network 14 and an other communication network 16. Other network 16 may be embodied, by way of example and not by way of limitation, in the Internet.

Cellular telephone network 12 includes mobile phones, represented by mobile phone 13, wirelessly coupled with a Mobile Telephone Switch (MIS) 20 for placing an emergency 9-1-1 call via an Emergency Call Routing Telephone Switch (ECRTS) 22. By way of example and not by way of limitation, MTS 20 may be embodied in a Mobile Switching Center (MSC). Cellular telephone network 12 may also include a Location Emergency Information Server (LEIS) 24.

Emergency telephone network 14 includes ECRTS 22 and at least one Public Safety Answering Point (PSAP; sometimes referred to as a Public Safety Answering Position) 30. ECRTS 22 is coupled with a media server 32, a Routing Emergency Information Server (REIS) 34 and LEIS 24. LEIS 24 can be queried by at least MTS 20 (within cellular telephone network 12 and ECRTS 22.

A 9-1-1 authority 40 is coupled with other network 16. 9-1-1 authority 40 may be a designated call taker located at PSAP 30 or another operator associated with emergency telephone network or with another network not shown in FIG. 1. A Polygon Management Unit (PMU) 42 is coupled with other network 16 and with a Geographic Information System (GIS) 44. A map database 43 is associated with GIS 44. A polygon database 45 is coupled with GIS 44 and with REIS 34. Media server 32 is coupled with other network 16 and is configured to accept a voice message provided by 9-1-1 authority 40 via other network 16.

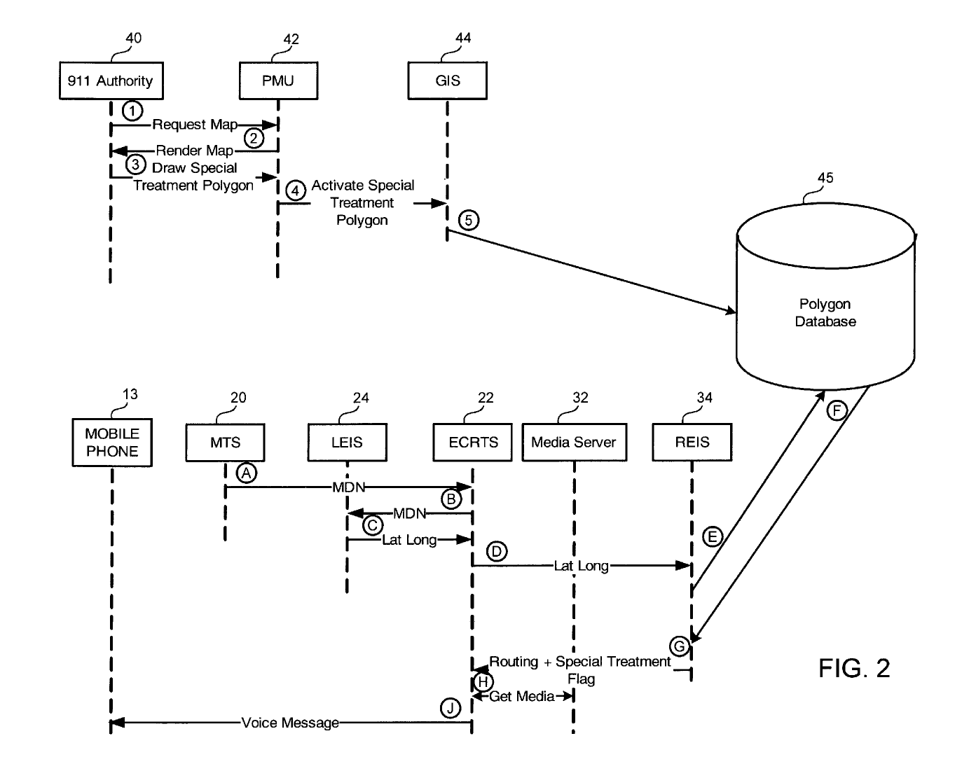

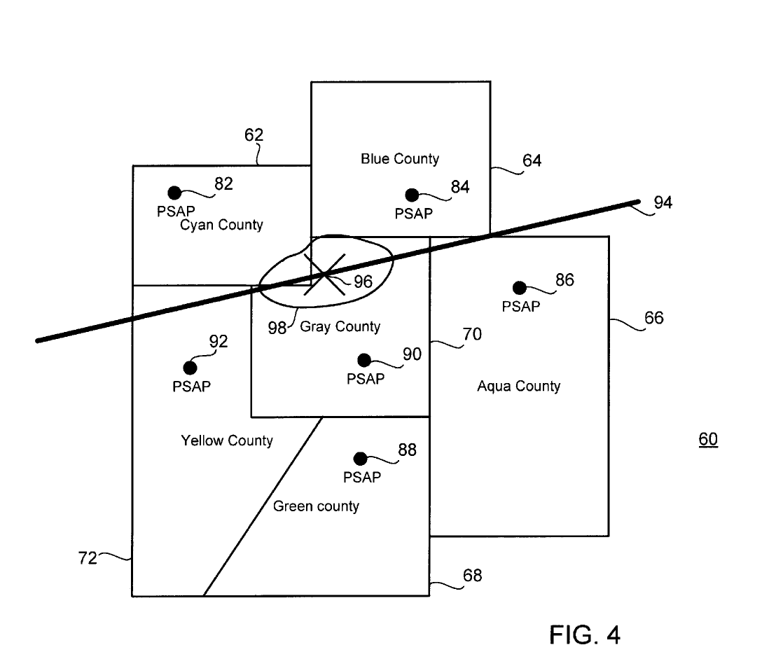

In a situation such as the scenario described above in BACKGROUND, by way of example and not by way of limitation, 9-1-1 Authority 40 may react by accessing PMU 42 via other network 16 (e.g., the Internet) retrieve a map of appropriate jurisdiction and draw a polygon on the retrieved map generally as described below in connection with FIG. 4. A representative call flow relating to effecting such a response is described below in connection with FIG. 2.

FIG. 2 illustrates call flow in the system of the present invention after a cellular phone places an emergency service call to 9-1-1. Regarding FIGS. 1 and 2 together, a PSAP 30 has been contacted by a mobile phone 13 and a report has been made of a need for emergency services within a particular geographic area. The extant call may be the most recent of a plurality of calls reporting a similar event at the particular geographic area, thus giving rise to employment of the present invention. To implement the present invention, 9-1-1 authority 40 places a call to PMU 42 (via other network 16) to request a map covering the particular geographic area (call #1). PMZU 42 responds to 9-1-1 authority 40 to render or otherwise provide the requested map (call #2). 9-1-1 authority 40 employs a graphic program or similar tool to draw or otherwise define a special treatment polygon substantially enclosing the particular geographic area and provides the special treatment polygon to PMU 42 (call #3). PMU 42 activates the special treatment polygon and provides the special treatment polygon to GIS 44 (call #4). GIS 44 provides the special treatment polygon to polygon data base 45 (call #5).

In a parallel calling arrangement occurring generally contemporaneously with calls #1-5, a mobile phone 13 (not necessarily the same mobile phone as the one that instituted events involving calls #1-5) places a 9-1-1 call within cellular telephone network 12 handled by MTS 20. MTS 20 provides the Mobile Dialing Number (MDN) or other identification relating to mobile phone 13 to ECRTS 22 (call A). ECRTS 22 provides the MDN to LEIS 24 to ascertain location of mobile phone 13 (call B). LEIS 24 provides location information to ECRTS 22 (call C). Location information may be provided in one or more formats including, by way of example and not by way of limitation, latitude-longitude coordinates, GPS (Global Positioning System) coordinates, LORAN coordinates, OMEGA coordinates or other coordinates identifying location of mobile phone 13. ECRTS 22 provides location information to REIS 34 (call D). REIS 34 queries polygon database 45 to ascertain whether the location reported for mobile phone 13 is within a special treatment polygon (call E). In this exemplary situation illustrated in FIG>2, mobile phone 13 is situated within a special treatment polygon, and polygon database 45 responds with that information to REIS 34 (call F). REIS 34 provides an appropriate routing and special treatment flag to ECRTS 22 alerting ECRTS 22 of the extant special treatment polygon. ECRTS 22 obtains an appropriate media content from media server 32 (call H). The media content obtained from media server may be a voice message prepared by 9-1-1 authority 40 and passed as a part of or otherwise associated with the definition of the special treatment polygon (calls #3-5 and calls F-G). ECRTS 22 provides the media content, such as by way of example and not by way of limitation a voice message to mobile phone 13. By way of further example and not by way of limitation, the media content may include one or more of a voice message, a text message, a video message or another format message.

Using call handling system 10 (FIG. 1), a 9-1-1 authority 40, such as a PSAP operator, may use a computer with Internet access and running a common WEB browser to access an electronic map of the region served by the PSAP. Using a mouse or other data entry device, 9-1-1 authority 40 may draw a polygon on the electronic map, thereby defining a special treatment region. Once the special treatment polygon or region has been defined, 9-1-1 authority 40 can arrange to provide a voice message to be played only to cellular callers dialing 9-1-1 while physically inside the region defined by the polygon. The voice message might say something like “If you are calling about the accident on 125 near mile marker 247 please hang up. For any other emergency please stay on the line.” The special treatment region and its associated special call treatment may persist only for a preset time interval, or may require action by 9-1-1 authority 40 to be terminated or may require renewal after a preset time interval has elapsed. When the special treatment region and its associated special call treatment terminates, emergency calls are again immediately routed to an appropriate PSAP.

Temporarily blocking a cellular 9-1-1 call to play an audio announcement because the caller is calling from a physical region defined by a 9-1-1 authority provides a caller an opportunity to terminate the call if the caller is seeking to report the particular incident that is identified in the audio announcement.

Current 9-1-1 switching network technology relies on associating a pseudo telephone number with a cellular 9-1-1 call, then using that pseudo telephone number to query a static database. Current 9-1-1 switching network technology is not capable of solving the problem that this invention solves.

The employment of an Emergency Call Routing Telephone Switch (ECRTS 22) for directly accessing a Location Emergency Information Server (LEIS 24) for obtaining location of a cellular telephone placing a call to 9-1-1, and employing an Emergency Call Routing Telephone Switch (ECRTS 22) to querying a Routing Emergency Information Server (REIS 34) to determine whether the location of the cell phone calling 9-1-1 is located in a physical region defined by a 9-1-1 authority (9-1-1 authority 40) is a useful and novel employment of network technology to solve a previously unaddressed problem.

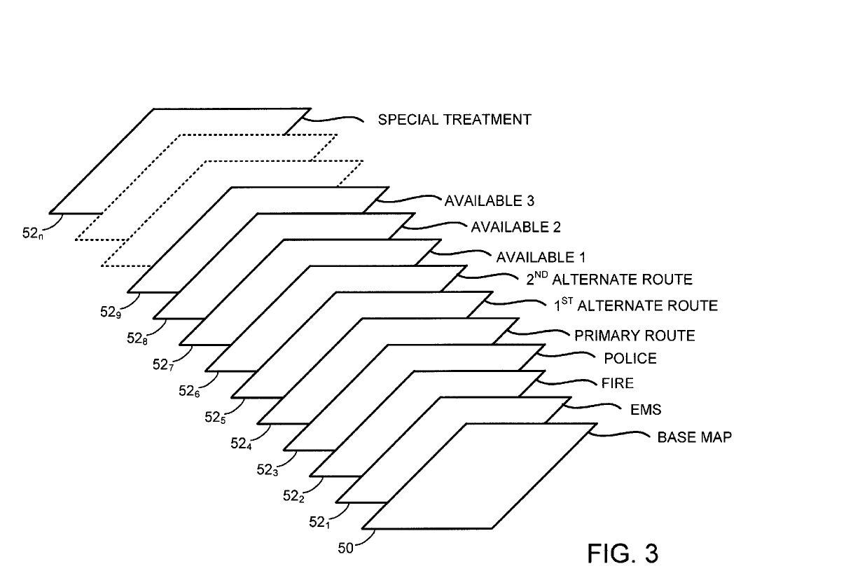

FIG. 3 is a schematic diagram illustrating arranging polygons for particular purposes in presenting geographic data. In FIG. 3, a base map 50 is illustrated as having a plurality of polygons 52ₙ defined for relating predetermined geographic features associated with base map 50. By way of example and not by way of limitation, a polygon 52₁ may be defined for relating boundaries for areas of responsibility for different EMS (Emergency Medical Service) entities. Different organizations, such as different counties or different cities, may sponsor respective EMS agencies. Each respective EMS agency may be assigned a respective geographic area of responsibility that may be set forth graphically in polygon 52₁.

Similarly, a polygon 52₂ may be defined for relating boundaries for areas of responsibility for different fire fighting entities. A polygon 52₃ may be defined for relating boundaries for areas of responsibility for different police entities. A polygon 52₄ may be defined for relating primary routes available to or assigned by an emergency service call taker, such as by way of example and not by way of limitation, an operator at PSAP 30 or 9-1-1 authority 40 (FIG. 1). Polygons 52₅, 52₆ may be defined for relating alternate routes available to or assigned by an emergency service call taker. Polygons 52₇, 52₈, 52₉ may be available for defining other geographic features relating to base map 50. Polygons 52₁, 52₂, 52₃, 52₄, 52₅, 52₆, 52₇, 52₈, 52₉ may be predetermined and maintained in a “library” available for use and application as needed, or may be created in an ad hoc manner, by way of example and not by way of limitation, by an operator at PSAP 30 or 9-1-1 authority 40 (FIG. 1). PMU 42 or a similar unit (not shown in FIGS. 1-3) may be employed for establishing a respective polygon 52ₙ.

Polygon 52ₙ may be defined for establishing a special treatment polygon substantially circumscribing a site of an event that is occasioning multiple emergency service calls, according to the teachings of the present invention. The indicator “n” is employed to signify that there can be any number of polygons available for definition relating to base map 50. The inclusion of ten polygons 52₁, 52₂, 52₃, 52₄, 52₅, 52₆, 52₇, 52₈, 52₉, 52ₙ, in FIG. 3 is illustrative only and does not constitute any limitation regarding the number of polygons that may be available for definition relating to base map 50 in connection with the present invention.

FIG. 4 is a schematic diagram illustrating application of a polygon to a geographic presentation. In FIG. 4, a geographic area 60 includes a plurality of counties: Cyan County 62, Blue County 64, Aqua County 66, Green County 68, Gray County 70 and Yellow County 72. Each respective county has a respective PSAP: Cyan County 62 has a PSAP 82, Blue County 64 has a PSAP 84, Aqua County 66 has a PSAP 86, Green County 68 has a PSAP 88, Gray County 70 has a PSAP 90 and Yellow County 72 has a PSAP 82.

A road 94 such as, by way of example and not by way of limitation, an Interstate Highway traverses geographic area 60. An emergency service event, such as by way of example and not by way of limitation an automobile accident, occurs at an event locus 96 substantially on road 94.

Numerous drivers passing by event locus 96, driving in either direction on road 94 (or driving on cross roads intersecting road 94; not shown in FIG. 4) may dial 9-1-1 to report the accident. On very busy interstates it is possible that hundreds of cellular 9-1-1 calls may be made to report the same accident. Such a relatively sudden surge in 9-1-1 call volume can swamp a PSAP and occupy all of the call takers at the PSAP, thereby possibly preventing the call takers from responding to an emergency call regarding another emergency that is unrelated to the accident.

Referring to FIGS. 1-4 together, a 9-1-1 authority 40 may use a computer with Internet access and running a common WEB browser to access an electronic map of geographic area 60. Using a mouse or other data entry device, 9-1-1 authority 40 may draw a special treatment polygon 98 on an electronic map of geographic area 60 substantially surrounding event locus 96, thereby defining a special treatment region. Once the special treatment polygon or region has been defined, 9-1-1 authority 40 can arrange to provide a voice message to be played only to cellular callers dialing 9-1-1 while physically inside special treatment polygon 98. The voice message might say something like “If you are calling about the accident on Intestate Highway (road 94; FIG. 4) near mile marker 247 (event locus 96; FIG. 4) please hang up. For any other emergency please stay on the line.” The special treatment region defined by special treatment polygon 98 and its associated special call treatment may persist only for a preset time interval, may require action by 9-1-1 authority 40 to be terminated or may require renewal after a preset time interval has elapsed. Such a finite interval of effectiveness may be imposed by a 9-1-1 authority 40 when special treatment polygon 98 is created by providing 9-1-1 authority 40 an opportunity to accompany a request for establishing special treatment polygon 98 with a duration limitation. When the special treatment region defined by special treatment polygon 98 and its associated special call treatment terminates, emergency calls may again be immediately routed to an appropriate PSAP 30.

With regard to special treatment polygon 98, a system associated with 9-1-1 authority 40 or PSAP 30 or otherwise available to 9-1-1 authority 40 may assist a creator of special treatment polygon 98 by providing an “autocreate” function that may review recent call history from cell towers exhibiting a very recent spike in volume of 9-1-1 calls. Based on data relating to recent 9-1-1 call volumes the autocreate function may suggest a polygon for employment as special treatment polygon 98. Such an autocreate system may also add situational intelligence regarding features of areas within geographic areas. Using such situational intelligence a system may suggest a shape such as a rectangle for use along an Interstate highway or a circle for an inner city location. 9-1-1 authority 40 may accept a polygon suggested by a system, employ a mouse or other data entry device to change the suggested polygon as desired or may delete the suggested polygon altogether and enter a desired special treatment polygon 98 substantially as described above.

A system employed by 9-1-1 authority 40 or another operator may be configured to accept shape files created independently of polygon data base 43 and map data base 45. With such a configuration and capability a 9-1-1 authority 40 or PSAP 30 may have a library of pre-prepared polygons stored in a local system at 9-1-1 authority 40, at PSAP 30 or at another location accessible by 9-1-1 authority 40 or PSAP 30. Such pre-prepared polygon may be configured with anticipation of events occurring at certain locations, such as along an Interstate highway. Using such pre-prepared polygons a 9-1-1 authority 40 may simply select a particular polygon from a locally prepared and stored library of polygons, perhaps couple the polygon with a pre-prepared voice message, and transmit the selected polygon and associated pre-prepared voice message to PMU 42 and media server 32.

A system employed by 9-1-1 authority 40 or another operator may be configured to exhibit “situational intelligence” so that the system may play a warning audio message to a caller and then substantially immediately sent the caller to an Automatic Call Distributor (ACD) queue. If, by way of example and not by way of limitation, the caller is a cellular caller calling from a specific region located within a special treatment polygon 98, a message may be played with an additional message such as “Please transmit a picture if you can.” The system may thereafter relate any pictures received with the incident associated with special treatment polygon 98.

Special treatment polygon 98 may be used in connection with either wireline calls or wireless calls. By way of example and not by way of limitation, a temporary situation may exist because of a visiting dignitary staying at a local hotel. Any calls, regardless whether they originate from a cellular network or a wireline network, coming from a geographic region surrounding the hotel (established as a special treatment polygon 98) could be sent to a particular PSAP designated to handle emergencies associated with the visiting dignitary. Any wireline calls originating from specific telephone numbers located within special treatment polygon 98 cold be handled in a manner similar to the handling of cellular calls, as described above. This may involve establishing a Wireline REIS and a Wireline ECRTS similar in function to REIS 34 and ECRTS 22 (FIG. 1) but configured and coupled for handling wireline calls. By way of example and not by way of limitation, if the President is staying a particular hotel, then any calls coming from a region immediately surrounding the particular hotel may be routed to a special PSAP at which a secret service agent may be stationed who can react more quickly than may otherwise be possible to a potential threat against the President.

A system employed by 9-1-1 authority 40 or another operator may be configured to provide logging and real-time information to a PSAP 30 regarding impact on call volume that is caused by a special treatment polygon 98. By tracking the ratio of calls made within a special treatment polygon 98 to calls abandoned from inside the special treatment polygon 98, one may determine effectiveness of employing special treatment polygon 98.

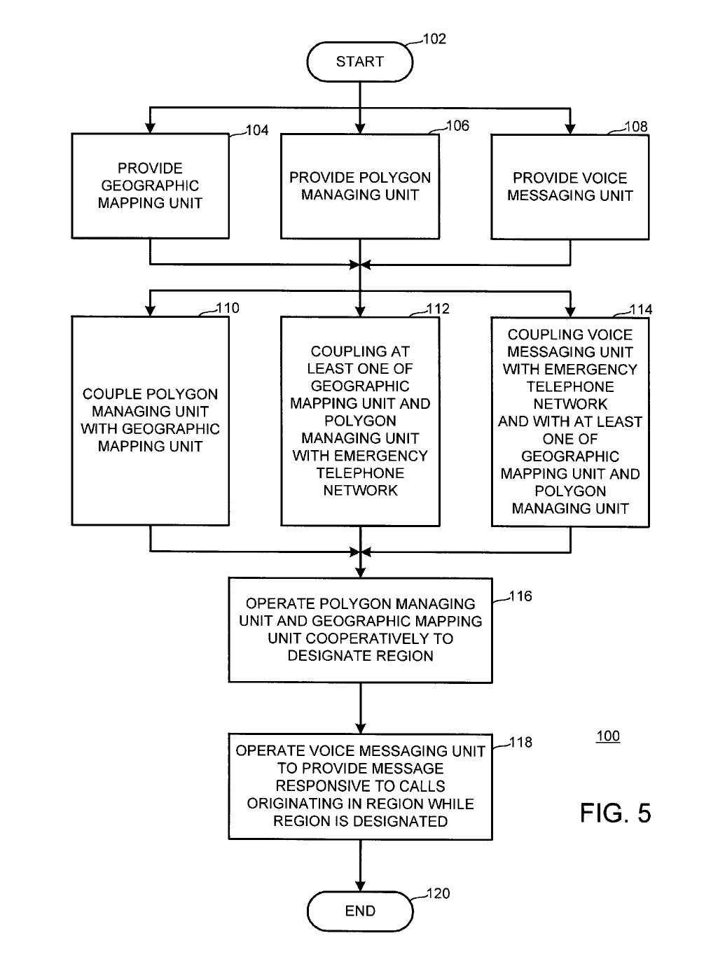

FIG. 5 is a flow diagram illustrating the method of the present invention. In FIG. 5, a method 100 for effecting special treatment of emergency service calls handled by an emergency telephone network and originating in a temporarily designated region begins at a START locus 102. Method 100 continues with, in no particular order: (1) providing a geographic mapping unit, as indicated by a block 104; (2) providing a polygon managing unit, as indicated by a block 106; and (3) providing a voice messaging unit, as indicated by a block 108.

Method 100 continues with, in no particular order: (1) coupling the polygon managing unit with the geographic mapping unit, as indicated by a block 110; (2) coupling at least one of the geographic mapping unit and the polygon managing unit with the emergency telephone network, as indicated by a block 112; and (3) coupling the voice messaging unit with the emergency telephone network and with at least one of the geographic mapping unit and the polygon managing unit, as indicated by a block 114.

Method 100 continues with operating the polygon managing unit and the geographic mapping unit cooperatively to effect designation of the region, as indicated by a block 116.

Method 100 continues with operating the voice messaging unit to provide a voice message responsive to the emergency service calls originating in the region substantially while the region is designated, as indicated by a block 118. Method 100 terminates at an END locus 120.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A system for effecting special treatment of emergency service calls originating in a temporarily designated region; the system comprising:
(a) a geographic mapping unit;
(b) a polygon managing unit coupled with said geographic mapping unit; at least one of said geographic mapping unit and said polygon managing unit being coupled with an emergency telephone network handling said emergency service calls; said polygon managing unit and said geographic mapping unit cooperating to effect designation of said region; and
(c) a voice messaging unit coupled with said emergency telephone network and coupled with at least one of said geographic mapping unit and said polygon managing unit; said voice messaging unit providing a voice message responsive to said emergency service calls originating in said region substantially while said region is designated.

2. A system for effecting special treatment of emergency service calls originating in a temporarily designated region as recited in claim 1 wherein said voice message advises that an emergency situation in said region has already been reported.

3. A system for effecting special treatment of emergency service calls originating in a temporarily designated region as recited in claim 2 wherein said voice message further advises that a caller may effect a further step to connect the extant call with an emergency service call taking entity.

4. A system for effecting special treatment of emergency service calls originating in a temporarily designated region as recited in claim 1 wherein said region is designated after a predetermined number of emergency service calls are received within a predetermined time interval and originating within a predetermined distance of each other.

5. A system for effecting special treatment of emergency service calls originating in a temporarily designated region as recited in claim 1 wherein at least one station in said emergency call taking entity is authorized to initiate said designation of said region and said providing said voice message.

6. A system for effecting special treatment of emergency service calls originating in a temporarily designated region as recited in claim 4 wherein said voice message advises that an emergency situation in said region has already been reported.

7. A system for effecting special treatment of emergency service calls originating in a temporarily designated region as recited in claim 6 wherein said voice message further advises that a caller may effect a further step to connect the extant call with an emergency service call taking entity.

8. A system for reducing numbers of repeat emergency service calls relating to an incident arriving via an emergency communication network at an emergency call taking facility; said incident occurring at an incident locus; the system comprising:
(a) at least one geographic mapping unit;
(b) at least one polygon managing unit; at least one of said at least one geographic mapping unit and said at least one polygon managing unit being coupled with said emergency communication network; said at least one polygon managing unit cooperating with said at least one geographic mapping unit to effect designating an incident region substantially surrounding said incident locus; and
(c) an alerting unit coupled with said emergency communication network and coupled with at least one of said at least one geographic mapping unit and said at least one polygon managing unit; said alerting unit providing an alert indication responsive to said repeat emergency service calls originating from said incident region while said incident region is designated.

9. A system for reducing numbers of repeat emergency service calls relating to an incident arriving via an emergency communication network at an emergency call taking facility as recited in claim 8 wherein said alert indication is a voice message advising that an emergency situation in said incident region has already been reported.

10. A system for reducing numbers of repeat emergency service calls relating to an incident arriving via an emergency communication network at an emergency call taking facility as recited in claim 9 wherein said voice message further advises that a caller may effect a further step to connect the extant call with an emergency service call taking facility.

11. A system for reducing numbers of repeat emergency service calls relating to an incident arriving via an emergency communication network at an emergency call taking facility as recited in claim 8 wherein said incident region is designated after a predetermined number of emergency service calls are received within a predetermined time interval and originating within a predetermined distance of each other.

12. A system for reducing numbers of repeat emergency service calls relating to an incident arriving via an emergency communication network at an emergency call taking facility as recited in claim 8 wherein at least one station in said emergency call taking facility is authorized to initiate said designating said incident region and said providing said alert indication.

13. A system for reducing numbers of repeat emergency service calls relating to an incident arriving via an emergency communication network at an emergency call taking facility as recited in claim 11 wherein said alert indication is a voice message advising that an emergency situation in said incident region has already been reported.

14. A system for reducing numbers of repeat emergency service calls relating to an incident arriving via an emergency communication network at an emergency call taking facility as recited in claim 13 wherein said voice message further advises that a caller may effect a further step to connect the extant call with an emergency service call taking facility.

15. A method for effecting special treatment of emergency service calls handled by an emergency telephone network and originating in a temporarily designated region; the method comprising:
(a) in no particular order:
(1) providing a geographic mapping unit;
(2) providing a polygon managing unit; and
(3) providing a voice messaging unit;
(b) in no particular order:
(1) coupling said polygon managing unit with said geographic mapping unit;
(2) coupling at least one of said geographic mapping unit and said polygon managing unit with said emergency telephone network; and
(3) coupling said voice messaging unit with said emergency telephone network and with at least one of said geographic mapping unit and said polygon managing unit;
(c) operating said polygon managing unit and said geographic mapping unit cooperatively to effect designation of said region; and
(d) operating said voice messaging unit to provide a voice message responsive to said emergency service calls originating in said region substantially while said region is designated.

16. A method for effecting special treatment of emergency service calls handled by an emergency telephone network and originating in a temporarily designated region as recited in claim 15 wherein said voice message advises that an emergency situation in said region has already been reported.

17. A method for effecting special treatment of emergency service calls handled by an emergency telephone network and originating in a temporarily designated region as recited in claim 16 wherein said voice message further advises that a caller may effect a further step to connect the extant call with an emergency service call taking entity.

18. A method for effecting special treatment of emergency service calls handled by an emergency telephone network and originating in a temporarily designated region as recited in claim 15 wherein said region is designated after a predetermined number of emergency service calls are received within a predetermined time interval and originating within a predetermined distance of each other.

19. A method for effecting special treatment of emergency service calls handled by an emergency telephone network and originating in a temporarily designated region as recited in claim 18 wherein said voice message advises that an emergency situation in said region has already been reported.

20. A method for effecting special treatment of emergency service calls handled by an emergency telephone network and originating in a temporarily designated region as recited in claim 20 wherein said voice message further advises that a caller may effect a further step to connect the extant call with an emergency service call taking entity.
